(19) United States
(12) Patent Application Publication
(10) Pub. No.: US 2025/0171989 A1
(43) Pub. Date: May 29, 2025

(54) SHOWER WATER SUPPLY DEVICE AND A WATER DISCHARGE METHOD THEREOF

(71) Applicants: Kohler (China) Investment Co., Ltd., Shanghai (CN); Beijing Kohler Ltd., Beijing (CN)

(72) Inventors: Junfeng SUN, Shanghai (CN); Shaopei WEI, Beijing (CN); Qingfa AI, Beijing (CN)

(73) Assignees: Kohler (China) Investment Co., Ltd., Shanghai (CN); Beijing Kohler Ltd., Beijing (CN)

(21) Appl. No.: 18/962,345

(22) Filed: Nov. 27, 2024

(30) Foreign Application Priority Data
Nov. 28, 2023 (CN) 202311608579.5
Nov. 28, 2023 (CN) 202323226062.8

(51) Int. Cl. E03C 1/04; B05B 1/16; B05B 1/18

(52) U.S. Cl. CPC E03C 1/0408; B05B 1/16; B05B 1/18

(57) ABSTRACT

The application discloses a shower water supply device and a water discharge method thereof. The shower water supply device comprises a shower body and a waterway switching assembly. The waterway switching assembly comprises a control pipe, an inlet pipe, a first outlet pipe, a second outlet pipe and a control member. The control pipe comprises a first control end, a second control end and a side opening. The control pipe has a valve core inside; the first outlet pipe comprises a first outlet. The control member is used to control on-and-off of water supply from the inlet pipe to the control member, to the control water discharge from a shower water chamber or a bubble water chamber. The water discharge method of the shower water supply device controls the shower water supply device to discharge water.

### CROSS-REFERENCE TO RELATED PATENT APPLICATIONS

This application claims the benefit of priority to Chinese Patent App. No. 202311608579.5, filed Nov. 28, 2023, and the benefit of priority to Chinese Utility Model patent application Ser. No. 20/232,3226062.8, filed Nov. 28, 2023, the disclosure of which are incorporated herein in their entirety for all purposes.

### BACKGROUND

A bubbler is a component that causes water flowing to have a foaming effect. The bubbler mixes the flowing water with air, which can improve the flushing effect of the water flowing, and at the same time effectively save the water. Bubblers are increasingly applied in shower systems because of its good performance.

Currently, bubblers are generally provided inside the showers. The showers need to provide two inlet pipelines to supply water to a shower water chamber and a bubble water chamber respectively, resulting in a relatively complex structure of the shower water supply pipeline; and the user needs to adjust different buttons to control the shower water chamber and bubble water chamber to discharge water respectively in the process of use, which increases the complexity of the use of the shower water, and the user experience needs to be enhanced.

### SUMMARY

The disclosure aims to provide a shower water supply device and a water discharge method thereof to simplify the structure of a water supply pipeline of a shower, simplify the water discharge manner of the shower, and enhance the user experience. The device and method can be used in bathing systems (e.g., shower systems, bathtub systems, etc.).

One aspect of the disclosure relates to a shower water supply device, that includes a shower body and a waterway switching assembly. The shower body includes a shower water chamber and a bubble water chamber. The bubble water chamber includes (e.g., internally includes) a bubbler. The bubbler mixes water with air in the bubble water chamber in order for the bubble water chamber to spray out a bubble water. The waterway switching assembly includes a control pipe, an inlet pipe, a first outlet pipe and a second outlet pipe, and a control member. The inlet pipe, the first outlet pipe, and the second outlet pipe are in communication with the control pipe. The control pipe includes a first control end and a second control end arranged in a lengthwise direction, and a side opening positioned between the first control end and the second control end. The control pipe internally includes a valve core movably positioned between the first control end and the second control end. When the valve core is moved to the first control end, the valve core and the first control end are located on the same side of the side opening. When the valve core is moved to the second control end, the valve core and the second control end are located on the same side of the side opening, The inlet pipe is in communication with and positioned between the side opening and shower water. The first outlet pipe is in communication with and positioned between the first control end and the shower water chamber. The first outlet pipe includes a first outlet that allows for the valve core to be moved to the first control end under an inertial force of water flowing into the first outlet pipe after a first water supply from the inlet pipe to the control pipe is completed during a single shower water discharge cycle. The second outlet pipe is in communication with and positioned between the second control end and the bubble water chamber. The control member is used to control on-and-off of the water supply from the inlet pipe to the control member to control the discharge of water from the shower water chamber or the bubble water chamber.

In various embodiments, the first control end is located above the second control end.

In various embodiments, during a single shower water discharge cycle, the inlet pipe supplies water to the control pipe for a first time. The valve core is limited at the second control end under water pressure. Water is discharged from the first outlet of the first outlet pipe to cause the shower water chamber to spray water. When the inlet pipe stops supplying water after the first time, the valve core is pulled upward and moved to the first control end by the inertial pulling force of water flow in the first outlet pipe. The height of the first outlet is lower than the height of the first control end, in order to make the valve core coupled to and maintained at the first control end under the gravitational force of water flow in the first outlet pipe. The inlet pipe starts to supply water to the control pipe for a second time according to a second water supply time before or at a preset water supply stopping interval, in order to limit the valve core at the first control end by water pressure before the valve core falls. The second outlet pipe discharges water to spray bubble water from the bubble water chamber. In some embodiments, the inlet pipe starts to supply water to the control pipe for the second time after a preset water supply stopping interval in order to limit the valve core at the second control end by water pressure after the valve core has dropped down to the second control end, and the first outlet pipe discharges water to spray water from the shower water chamber.

In various embodiment, the first control end includes a first step for limiting the valve core, and the second control end includes a second step for limiting the valve core.

In various embodiments, there is a clearance between the valve core and the second step.

In various embodiments, the clearance between the valve core and an inner wall of the control pipe is L, wherein 0.1 mm≤L≤2 mm.

In various embodiments, the inlet pipe is internally provided with a one-way control member for one-way water flow from the inlet pipe into the control pipe.

In various embodiments, one end of the inlet pipe is provided with a connecting bend. The connecting bend is connected to the side opening. The connecting bend is provided either horizontally or downwardly obliquely in a direction towards the side opening. The one-way control member is positioned inside the connecting bend.

In various embodiments, the control member includes a control switch. The shower water is a pressurized water. The control switch is positioned on the inlet pipe or on a water supply component for the pressurized water for controlling water discharge from the shower water chamber or the bubble water chamber by controlling on-and-off of the control switch.

In various embodiments, the water supply component is a shower column or a shower pipe. The water supply component includes a control base and the control switch is located on the control base.

One aspect of the disclosure relates to a water discharge method of a shower water supply device to control the shower water supply device described above. The method includes at least one of following steps: the control member is used to control on-and-off of the water supply from the inlet pipe to the control member to control the discharge of water from the shower water chamber or the bubble water chamber.

In various embodiments, the water discharge method also includes at least one of following steps: the first control end is disposed above the second control end; the control member controls the inlet pipe to supply water to the control pipe for the first time, the valve core is limited at the second control end under water pressure, and at this point, a shower water passes through the inlet pipe, the control pipe, and the first outlet pipe to make the shower water chamber spray water; the control member controls the inlet pipe to stop supplying water after the first time, the valve core is pulled upward and moved to and abuts against the first control end by the inertial pulling force of water flow in the first outlet pipe, and the height of the first outlet is lower than the height of the first control end, in order to make the valve core attached to and maintained at the first control end under the gravitational force of water flow in the first outlet pipe; the control member controls the inlet pipe to start to supply water to the control pipe for the second time according to the second water supply time before or at a preset water supply stopping interval, to limit the valve core at the first control end by water pressure before the valve core falls, and the second outlet pipe discharges water to spray bubble water from the bubble water chamber; or, the control member controls the inlet pipe to start to supply water to the control pipe for the second time after a preset water supply stopping interval to limit the valve core at the second control end by water pressure after the valve core has dropped down to the second control end, and the first outlet pipe discharges water to spray water from the shower water chamber.

By adopting the technical solutions above, the application has the following beneficial effects: the shower water supply device and a water discharge method thereof provided by this application achieve water discharge from the shower water chamber or the bubble water chamber and simplify the water supply pipeline structure of the shower by controlling on-and-off of the water inlet from the inlet pipe to the control pipe through the control member. Wherein the bubbler provided in the bubble water chamber mixes the water flow with air in the bubble water chamber, achieving the spraying of bubble water from the bubble water chamber, achieving flexible spraying on the head and other parts, enhancing the spraying effect and increasing the comfort of showering. The above water discharge process is controlled through the waterway switching assembly, simplifying the water discharge manner of the shower and enhancing the convenience of the use.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a longitudinal sectional view of a shower water supply device when water is supplied from an inlet pipe for a first time, according to an exemplary embodiment;

FIG. 2 is a structural schematic view of air entering into a first outlet pipe after the first water is supplied from the inlet pipe of FIG. 1, according to an exemplary embodiment;

FIG. 3 is a longitudinal sectional view of a shower water supply device when water is supplied from the inlet pipe for a second time, according to an exemplary embodiment;

FIG. 4 is a structural schematic view of the shower water supply device after the second water is supplied from the inlet pipe of FIG. 3, according to an exemplary embodiment;

FIG. 5 is a longitudinal sectional view of the shower water supply device after the second water supply from the inlet pipe has ended for a certain period of time;

FIG. 6 is a structural schematic view of the waterway switching assembly, according to an exemplary embodiment;

FIG. 7 is a partially enlarged view of Part A of FIG. 6;

FIG. 8 is a structural schematic view of the inlet pipe when the water is supplied for the first time, according to an exemplary embodiment;

FIG. 9 is a structural schematic view of the valve core being pulled upward and limited at the first control end after the first water is supplied from the inlet pipe, according to an exemplary embodiment;

FIG. 10 is a structural schematic view of the valve core being limited at a first control end when the water is supplied from the inlet pipe for the second time, according to an exemplary embodiment;

FIG. 11 is a structural schematic diagram of the valve core being moved to a second control end under inertia force of the water flow in the second outlet pipe and its own gravity after the second water is supplied from the inlet pipe, according to an exemplary embodiment;

FIG. 12 is a structural schematic view of the valve core falling back to an initial state under its own action after the second water is supplied from the inlet, according to an exemplary embodiment;

FIG. 13 is a structural schematic view of the control switch provided on the water supply component, according to an exemplary embodiment;

FIG. 14 is a first example flowchart of a water discharge method of the shower water supply device, according to an exemplary embodiment; and

FIG. 15 is a second example flowchart of a water discharge method of the shower water supply device, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

It is readily understood that, according to the technical solution of the application, a plurality of structural modes as well as implementation methods are interchangeable by those of ordinary skill in the art without changing the substantial spirit of the application. Therefore, the following specific implementations as well as the accompanying drawings are only exemplary illustrations of the technical solution of the application, and should not be regarded as the entirety of the application or be regarded as a limitation or restriction of the technical solution of the application.

The orientational terms such as “up”, “down”, “left”, “right”, “front”, “rear”, “back”, “upper”, “bottom”, etc., which are mentioned or may be mentioned in this specification, are defined in relation to the construction shown in the accompanying drawings, which are relative concepts, and are therefore likely to change accordingly depending on the different positions in which they are located and different usage states. Therefore, these or other orientation terms should also not be interpreted as restrictive terms. Therefore, these or other orientational terms should not be interpreted as restrictive terms.

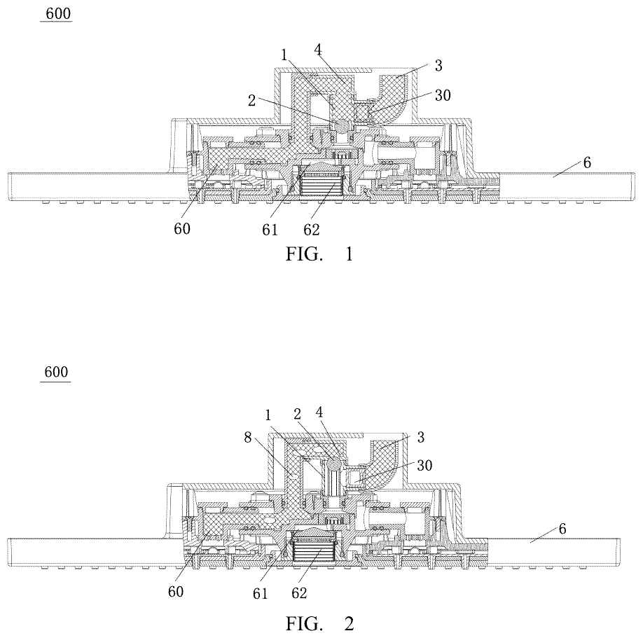

FIGS. 1-5 shows a shower water supply device 600. The water supply device 600 includes a shower body 6 and a waterway switching assembly 100.

The shower body 6 includes a shower water chamber 60 and a bubble water chamber 61. The bubble water chamber 61 includes (e.g., internally includes) a bubbler 62. The bubbler 62 mixes water with air in the bubble water chamber 61, in order for the bubble water chamber 61 to spray out a bubble water.

As shown in FIGS. 1-5, the shower body 6 in this disclosure provides shower water unmixed with air outwardly through the shower water chamber 60, and the bubble water with bubbles is discharged by coupling (e.g., mounting) the bubbler 62 in the bubble water chamber 61. Water discharge from the shower water chamber 60 or the bubble water chamber 61 is implemented by switching of the following described waterway switching assembly 100.

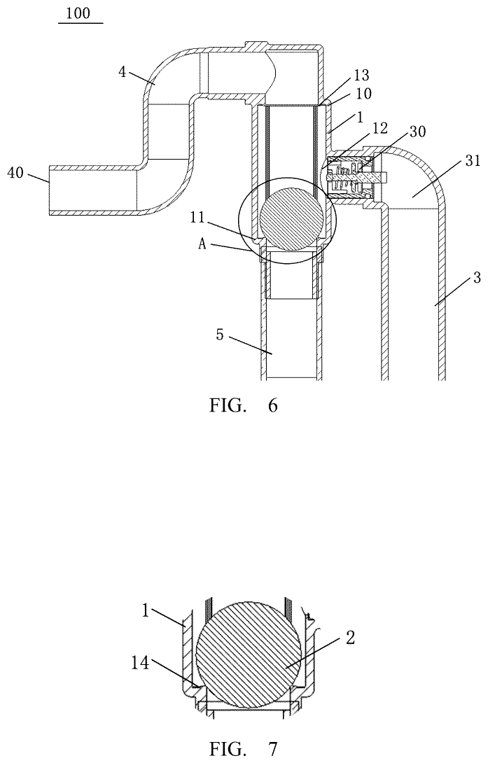

As shown in FIG. 6, the waterway switching assembly 100 includes a control pipe 1, an inlet pipe 3, a first outlet pipe 4 a second outlet pipe 5, and a control member. The inlet pipe 3, the first outlet pipe, and the second outlet pipe 5 are communicatively coupled to the control pipe 1. The control pipe 1 includes a first control end 10 and a second control end 11 arranged in a lengthwise direction. The control pipe 1 also includes a side opening 12 positioned between the first control end 10 and the second control end 11. The control pipe 1 internally includes a valve core 2 that is movably positioned between the first control end 10 and the second control end 11. When the valve core 2 is moved to the first control end 10, the valve core 2 and the first control end 10 are located on the same side of the side opening 12. When the valve core 2 is moved to the second control end 11, the valve core 2 and the second control end 11 are located on the same side of the side opening 12.

Referring to FIGS. 2, 3, 9, and 10, the valve core 2 and the first control end 10 are located on the same side of the side opening 12, which means that when the valve core 2 moves to the first control end 10, the entire valve core 2 is located on a side of the side opening 12 proximate to an inner wall of the first control end 10, or the valve core 2 is partially located between inner walls of the side opening 12. This configuration fulfills a requirement that the water pressure keeps the valve core 2 abutting against the first control end 10 when the side opening 12 supplies water to the control pipe 1.

Referring to FIGS. 1, 4, 6, 8, 11 and 12, the valve core 2 and the second control end 11 are located on the same side of the side opening 12, which means that when the valve core 2 moves to the second control end 11, the entire valve core 2 is located on a side of the side opening 12 proximate to an inner wall of the second control end 11, or the valve core 2 is partially located between the inner walls of the side opening 12. This configuration fulfills a requirements that the valve core 2 is kept abutting against the second control end 11 when the side opening 12 supplies water to the control pipe 1.

The inlet pipe 3 is in communication with the side opening 12 and shower water and positioned between the side opening 12 and shower water.

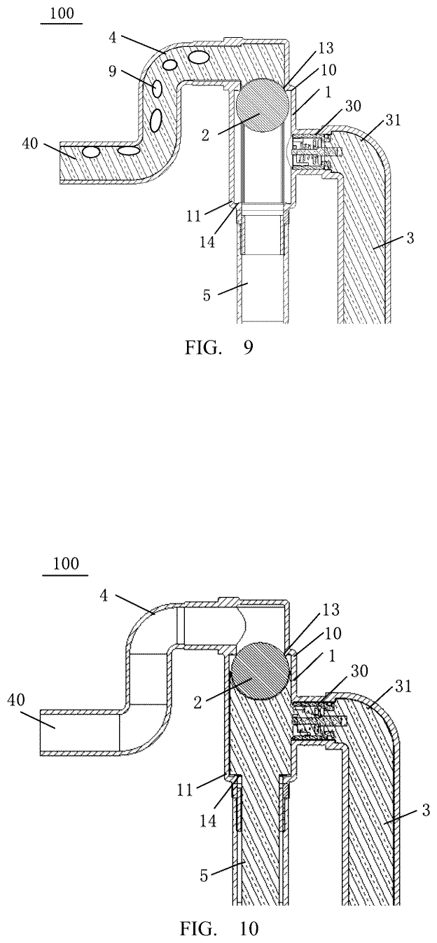

The first outlet pipe 4 is in communication with the first control end 10 and the shower water chamber 60 and positioned between the first control end 10 and the shower water chamber 60. The first outlet pipe 4 includes a first outlet 40. The valve core 2 tends to lift due to an inertial force of the water flow in the first outlet pipe 4 after the inlet pipe 3 stops supplying water to the first outlet pipe 4. In a single shower water discharge cycle, at the moment when the water supply from the inlet pipe 3 to the control pipe 1 stops for the first time, the water flow flowing at the first outlet 40 of the first outlet pipe 4 lifts the valve core 2 upward by inertial force, and the valve core 2 overcomes its own gravity and is limited at the first control end 10 under the upward pulling of the inertial force, as shown in FIGS. 2 and 9.

The second outlet pipe 5 is in communication with the second control end 11 and the bubble water chamber 61 and positioned between the second control end 11 and the bubble water chamber 61, as shown in FIGS. 1 to 5.

The control member is used to control on-and-off the water flow from the inlet pipe 3 to the control pipe 1 in order to drive the valve core 2 to move between the first control end 10 and the second control end 11 of the control pipe 1, and control the discharge of water from the shower water chamber 60 or the bubble water chamber 61.

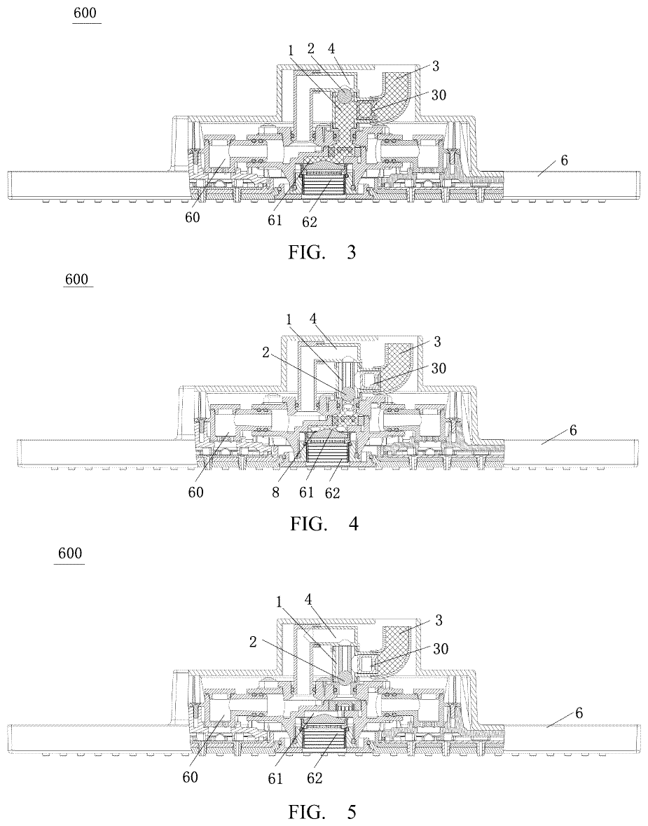

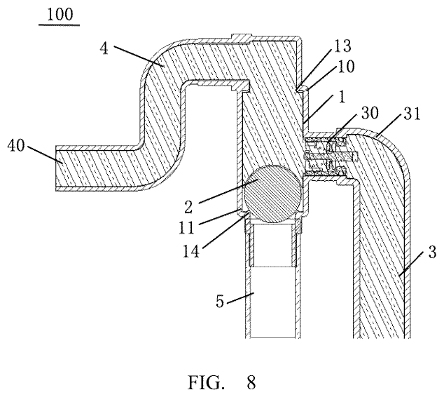

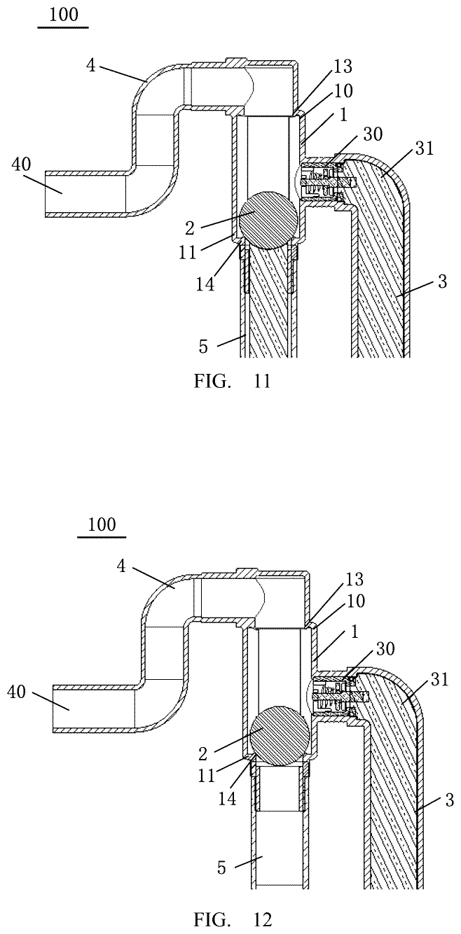

The following describes a single shower discharge cycle of the shower water supply device 600. The control member controls the inlet pipe 3 to supply water to the control pipe 1 for a first time according to a water supply time. At this time, the valve core 2 is limited at the second control end 11 under water pressure, as shown in FIGS. 1 and 8, in order to allow water to spray out of the first outlet 40 of the first outlet pipe 4 to the shower water chamber 60, and the outlet of the shower water chamber 60 begins to spray water outwardly. After the inlet pipe 3 stops supplying water for the first time, the valve core 2 is pulled by the inertial pull of the water flow in the first outlet pipe 4 and abuts against the first control end 10, as shown in FIGS. 2 and 9. The controller controls the on-and-off of the water supply from the inlet pipe 3 to the control member 1. When the valve core 2 abuts against the first control end 10, water is supplied for a second time. The shower water is sprayed from the bubble water chamber 61, as shown in FIGS. 3 and 10. Water is supplied when the valve core moves such that the valve core 2 and the second control end 11 are located on the same side of the side opening 12, and shower water begins to spray from the outlet of the shower water chamber 60 outwardly, as shown in FIGS. 1 and 8.

The shower water supply device 600 achieves water discharge from the shower water chamber 60 or the bubble water chamber 61 and simplifies the structure of the water supply pipeline of the bathing system by controlling on-and-off of the water inlet from the inlet pipe 3 to the control pipe 1 through the control member. The bubbler 62 in the bubble water chamber 61 mixes the water flow with air in the bubble water chamber 61, achieving the spraying of bubble water from the bubble water chamber 61 and flexible spraying on the head and other parts, enhancing the spraying effect, and increasing the comfort of showering. The above water discharge process is controlled through the waterway switching assembly 100, simplifying the water discharge manner of the shower and enhancing the convenience of the use.

In various embodiments, the first control end 10 is located above the second control end 11. As shown in FIGS. 1-5, in such embodiments, the first control end 10 is located above the second control end 11 along the direction of gravity. In an initial state, the valve core 2 abuts against the second control end 11 under its own gravity. In a single shower water discharge cycle, at the moment when the water supply from the inlet pipe 3 to the control pipe 1 stops after the first time, the water flow flowing at the first outlet 40 of the first outlet pipe 4 lifts the valve core 2 upward by inertial force, and the valve core 2 overcomes its own gravity and moves to the first control end 10 under the upward pulling of the inertial force, as shown in FIG. 4. After the inlet pipe 3 stops supplying water after the first time for a certain period of time, air starts to enter in the first outlet pipe 4, and the air is controlled to break the inertial force of the first outlet pipe 4 on the valve core 2, and the ball valve 2 moves and abuts against the second control end 11 under its own gravity.

In various embodiments, during a single shower water discharge cycle, the inlet pipe 3 supplies water to the control pipe 1 for the first time. The valve core 2 is limited at the second control end 11 under water pressure, such that water is sprayed from the first outlet 40 of the first outlet pipe 4 to cause the shower water chamber 60 to spray water, as shown in FIGS. 1 and 8.

When the inlet pipe 3 stops supplying water after the first time, the valve core 2 is pulled upward and moved to the first control end 10 by the inertial pulling force of water flow in the first outlet pipe 4. A height of the first outlet 40 is lower than a height of the first control end 10, so as to make the valve core 2 coupled and maintained at the first control end 10 under the gravitational force of water flow in the first outlet pipe 4, as shown in FIGS. 2 and 9. Specifically, at a moment when the water supply from the inlet pipe 3 to the control pipe 1 stops after the first time, the water flow at the first outlet 40 of the first outlet pipe 4 lifts the valve core 2 upward by inertial force, and the valve core 2 moves to the first control end 10 under an upward pulling function. Simultaneously, since the height of the first outlet 40 is lower than that of the valve core 2, the inverted U-shaped structure of the first outlet pipe 4 converts the gravity of the water into the suction force on the valve core 2 to keep the valve core 2 limited at an unchanging position at the first control end 10.

The inlet pipe 3 starts to supply water to the control pipe 1 for the second time according to a second water supply time before or at a preset water supply stopping interval, to limit the valve core 2 at the first control end 10 by water pressure before the valve core 2 falls, and the second outlet pipe 5 discharges water to spray bubble water from the bubble water chamber 61, allowing for the alternation of water discharge between the shower water chamber 60 and the bubble water chamber 61 to occur.

The inlet pipe 3 starts to supply water to the control pipe 1 for the second time after a preset water supply stopping interval in order to limit the valve core 2 at the second control end 11 by water pressure after the valve core 2 has dropped down to the second control end 11. The first outlet pipe 4 discharges water to spray water from the shower water chamber 60, allowing for a continuous water discharge from the shower water chamber 60.

The preset water supply stopping interval may be 0.5 seconds(s) or 0.8 s, or may be set between 0.1and 2.0 s. Specifically, this is the time duration from the time when the first water supply stops to the time when the air 8 gradually entering from the first outlet 40 breaks the upward suction of the inertial force of the water flow on the valve core 2 resulting in a fall of the valve core 2.

After the inlet pipe 3 stops the second water supply, the valve core 2 moves to the second control end 11, as shown in FIGS. 5 and 11. The duration of the first water supply time in this embodiment may be 3 s, or it may be selected between 2 s and 10 s by solenoid valve control. In other embodiments, the user may operate a mechanical valve to control the duration of the first water supply according to a desired water discharging time to achieve a better spraying effect of the shower water chamber 60.

At the moment when the water supply from the inlet pipe 3 to the control pipe 1 stops after the second time, the water flow in the second outlet pipe 5 pulls the valve core 2 downwardly and limits it at the second control end 11 by inertial force. The outlet of the second outlet pipe 5 is lower than the valve core 2, converting the gravity force of the water into a suction force on the valve core 2, which maintains the valve core 2 in an unchanging position together with the gravity of the valve core 2. At the same time, the air 8 gradually enters from a side of the first outlet pipe 4, and the air 8 breaks the inertial force of the water in the second outlet pipe 5 on the valve core 2. The duration of the second water supply in this embodiment may be 4 s, or it may be selected between 2 s to 10 s by solenoid valve control, or the user may operate the mechanical valve to control the duration of the first water supply according to the desired water discharging time to achieve a better spraying effect of the bubble water chamber water chamber 61.

In various embodiments, the first control end 10 includes a first step 13 for limiting the valve core 2, and the second control end 11 includes a second step 14 for limiting the valve core 2. As shown in FIGS. 6-12, the first step 13 on the first control end 10 acts as a role of abutting against and limiting the valve core 2, and the second step 14 on the second control end 11 acts a role of abutting against and limiting the valve core 2. When the valve core 2 is moved to the first step 13, the side opening 12 is located below the valve core 2. When the valve core 2 is moved to the second step 14, the side opening 12 is located above the valve core 2.

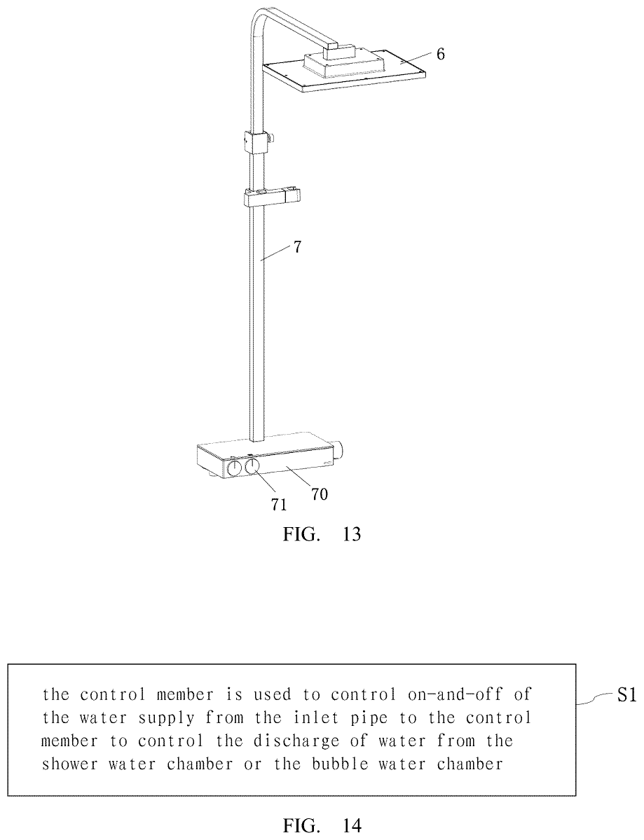

In various embodiments, there is a clearance between the valve core 2 and the second step 14. In such embodiments, the clearance left between the valve core 2 and the second step 14 can be used as a water drainage channel. This is achieved by providing a crevice on the second step 14. When the spherical valve core 2 abuts against the second step 14, the crevice and the valve core 2 define the clearance. After stopping the second water supply, the air 8 gradually enters from a side of the first outlet pipe 4, and the air 8 passes through the water drainage channel into the second outlet pipe 5 breaking the attraction of the water flow in the second outlet pipe 5 to the valve core 2. After a period of time, the waterway switching assembly 100 returns to its initial state as shown in FIGS. 5 and 12. The above process is repeated from the first water supply in the next single shower outlet cycle.

In various embodiments, the clearance between the valve core 2 and an inner wall of the control pipe 1 is L, wherein 0.1 millimeters (mm)≤L≤2 mm. Setting the clearance between 0.1 mm and 2 mm can satisfy the smooth movement of the valve core 2 in the control pipe 1 driven by the water pressure, and also avoid a large clearance between the valve core 2 and the inner wall of the control pipe 1, which affects the driving effect of the inertia of the water flow on the valve core 2.

In various embodiments, the inlet pipe 3 is includes a one-way control member 30 for one-way water flow from the inlet pipe 3 into the control pipe 1. The one-way control member 30 is used to isolate the inlet pipe 3 and the control pipe 1, and at the same time to achieve the effect of unidirectionally controlling the water flow from the inlet pipe 3 to the control pipe 1. In various embodiments, the one-way control member 30 is a one-way valve or a check valve.

In various embodiments, one end of the inlet pipe 3 includes a connecting bend 31. The connecting bend 31 is connected to the side opening 12 and is provided either horizontally or downwardly obliquely in a direction towards the side opening 12. The one-way control member 30 is positioned inside the connecting bend 31. In such embodiments, the connecting bend 31 provides an accommodation space for the one-way control member 30, and at the same time, the positioning of the connecting bend 31 is beneficial in preventing the water flow from gathering in the connection place between the connecting bend 31 and the control pipe 1, such that the water flowing cannot be discharged in a timely manner.

In various embodiments, the control member includes a control switch 71. The shower water is a pressurized water. The control switch 71 is positioned on the inlet pipe 3 or on a water supply component for the pressurized water and is configured to control water discharge from the shower water chamber 60 or the bubble water chamber 61 by controlling on-and-off of the control switch 71. The control switch 71 in such embodiments may be either a solenoid switch to control the on or off of the control switch 71 by a controller according to a preset time, or a manual switch to control the on or off of the control switch 71 by a user.

In various embodiments, the water supply component is a shower column 7 or a shower pipe and the water supply component includes a control base 70, with the control switch 71 located on the control base 70. As shown in FIG. 13, the control switch 71 has a shape and configuration of a button. In a single shower water discharge cycle, when the button is pressed for a first time, water will flow out from the shower water chamber 60; when the button is pressed for a second time, water comes out from the bubble water chamber 61; when the button is pressed for a third time before or at a preset water supply stopping interval, water will come out from the bubble water chamber 61, or when the button is pressed for the third time after the preset water supply stopping interval, water will come out from the shower water chamber 60; after pressing the button for a fourth time, the single shower water cycle ends and the shower water supply device stops supplying water.

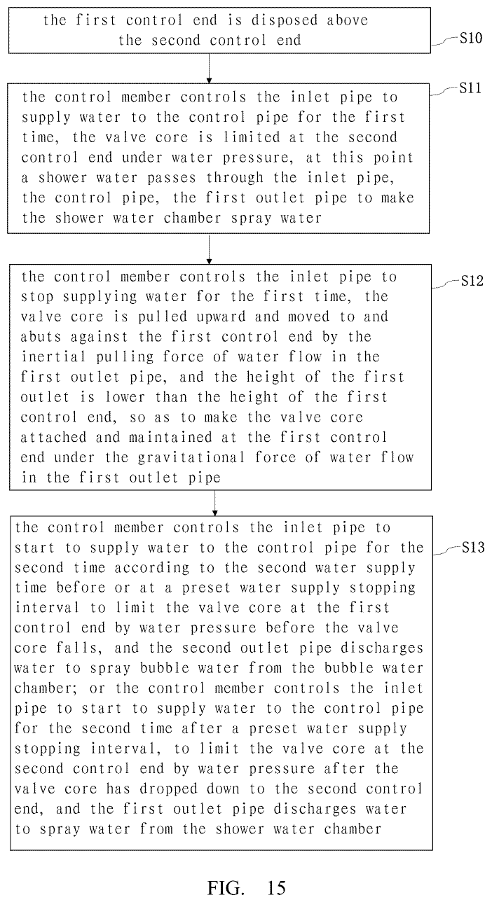

The application also provides a water discharge method of a shower water supply device to control the shower water supply device 600 in the embodiments above, as shown in FIG. 14, including the following step: S1, the control member is used to control on-and-off of the water supply from the inlet pipe 3 to the control member 1 to control the discharge of water from the shower water chamber 60 or the bubble water chamber 61.

The control member controls the inlet pipe 3 to supply water to the control pipe 1 for the first time according to the water supply time, at this time the valve core 2 is limited at the second control end 11 under water pressure, as shown in FIGS. 1 and 8, in order to allow water to spray out of the first outlet 40 of the first outlet pipe 4 to the shower water chamber 60, and the outlet of the shower water chamber 60 begins to discharge water outwardly. After the inlet pipe 3 stops supplying water after the first time, the valve core 2 is pulled by the inertial pull of the water flow in the first outlet pipe 4 and abuts against the first control end 10, as shown in FIGS. 2 and 9. The controller controls the on-and-off of the water supply from the inlet pipe 3 to the control member 1. When the valve core 2 abuts against the first control end 10, water is supplied for the second time, and the shower water is sprayed from the bubble water chamber 61, as shown in FIGS. 3 and 10. Water is supplied when the valve core moves such that the valve core 2 and the second control end 11 are located on the same side of the side opening 12, and shower water begins to spray from the outlet of the shower water chamber 60 outwardly, as shown in FIGS. 1 and 8.

In various embodiments, as shown in FIG. 15, the water discharge method also includes the step S10: the first control end 10 is disposed above the second control end 11. The first control end 10 is located above the second control end 11 along the direction of gravity. In the initial state, the ball valve 2 abuts against the second control end 11 under its own gravity. The water discharge method may also include S11: the control member controls the inlet pipe 3 to supply water to the control pipe 1 for the first time, the valve core 2 is limited at the second control end 11 under water pressure, at this point a shower water passes through the inlet pipe 3, the control pipe 1, the first outlet pipe 4 to make the shower water chamber 60 spray water.

With further reference to the method of FIG. 15, the method may also include S12: the control member controls the inlet pipe 3 to stop supplying water after the first time, the valve core 2 is pulled upward and moved to and abuts against the first control end 10 by the inertial pulling force of water flow in the first outlet pipe 4, and the height of the first outlet 40 is lower than the height of the first control end 10, so as to make the valve core 2 attached and maintained at the first control end 10 under the gravitational force of water flow in the first outlet pipe 4, as shown in FIGS. 2 and 9. Specifically, at the moment when the water supply from the inlet pipe 3 to the control pipe 1 stops after the first time, the water flow at the first outlet 40 of the first outlet pipe 4 pulls the valve core 2 upward by inertial force, and the valve core 2 moves to the first control end 10 under the upward pulling. At the same time, since the height of the first outlet 40 is lower than that of the valve core 2 and the inverted U-shaped structure of the first outlet pipe 4 converts the gravity of the water into the suction force on the valve core 2 to keep the valve core 2 limited at an unchanging position at the first control end 10.

The method also includes S13: the control member controls the inlet pipe 3 to start to supply water to the control pipe 1 for the second time, according to the second water supply time, before or at a preset water supply stopping interval in order to limit the valve core 2 at the first control end 10 by water pressure before the valve core 2 falls. In S13, the second outlet pipe 5 discharges water to spray bubble water from the bubble water chamber 61 or, the control member controls the inlet pipe 3 to start to supply water to the control pipe 1 for the second time after a preset water supply stopping interval, to limit the valve core 2 at the second control end 11 by water pressure after the valve core 2 has dropped down to the second control end 11, and the first outlet pipe 4 discharges water to spray water from the shower water chamber 60. The preset water supply stopping interval may be 0.5 s or 0.8 s, or may be set between 0.1 s and 2.0 s. Specifically, this is the time duration from the time when the first water supply stops to the time when the air 8 gradually entering from the first outlet 40 breaks the upward suction of the inertial force of the water flow on the valve core 2 resulting in the fall of the valve core 2.

After the inlet pipe 3 stops the second water supply, the valve core 2 moves to the second control end 11, as shown in FIGS. 5 and 11. The duration of the first water supply in this embodiment may be 3 s, or it may be selected between 2 s and 10 s by solenoid valve control to achieve a better spraying effect of the shower water chamber 60.

The above technical solutions may be combined as required to achieve the best technical effect. The above are merely the principle and the preferred embodiments of the application. It should be pointed out that, for those of ordinary skills in the art, several other modifications may be made on the basis of the principle of the application, which should also be regarded as falling in the protection scope of the application.

The above are merely the principle and the preferred embodiments of the application. It should be pointed out that, for those of ordinary skills in the art, several other modifications may be made on the basis of the principle of the application, which should also be regarded as falling in the protection scope of the application.

As utilized herein with respect to numerical ranges, the terms “approximately,” “relative to,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “relative to,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure. In addition, the terms “first”, “second” and “third” are used for descriptive purposes only and are not to be construed as indicating or implying relative importance.

Although the figures and description may illustrate a specific order of method steps, the order of such steps may differ from what is depicted and described, unless specified differently above. Also, two or more steps may be performed concurrently or with partial concurrence, unless specified differently above.

What is claimed is:

1. A shower water supply device, comprising:
a shower body comprising:
a shower water chamber, and
a bubble water chamber, the bubble water chamber including a bubbler, the bubbler configured to mix water with air in the bubble water chamber such that the bubble water chamber sprays out a bubble water; and
a waterway switching assembly comprising:
a control pipe, the control pipe comprising:
a first control end,
a second control end, the first control end and the second control end arranged in a lengthwise direction,
a side opening positioned between the first control end and the second control end, and
a valve core movably positioned between the first control end and the second control end,
an inlet pipe, coupled between the side opening and shower water,
a first outlet pipe coupled between the first control end and the shower water chamber and including a first outlet so that during a single shower water discharge cycle, the valve core is moved to the first control end under an inertial force of water flow in the first outlet pipe after a first water supply from the inlet pipe to the control pipe is completed;
a second outlet pipe coupled between the second control end and the bubble water chamber, the inlet pipe, the first outlet pipe, and the second outlet pipe in communication with the control pipe, and
a control member configured to control on-and-off of the water supply from the inlet pipe to the control member to control the discharge of water from the shower water chamber or the bubble water chamber;
wherein when the valve core is moved to the first control end, the valve core and the first control end are located on the same side of the side opening and when the valve core is moved to the second control end, the valve core and the second control end are located on the same side of the side opening.

2. The shower water supply device according to claim 1, wherein the first control end is located above the second control end.

3. The shower water supply device according to claim 2, wherein:
during the single shower water discharge cycle, the inlet pipe supplies water to the control pipe for a first time and the valve core is limited at the second control end under water pressure such that water is sprayed from the first outlet of the first outlet pipe and the shower water chamber sprays water;
when the inlet pipe stops supplying water after the first time, the valve core is pulled upward and moved to the first control end by an inertial pulling force of water flow in the first outlet pipe; and
when the inlet pipe starts to supply water to the control pipe for a second time according to a second water supply time before or at a preset water stopping interval in order to limit the valve core at the first control end by water pressure before the valve core falls, the second outlet pipe discharges water to spray bubble water from the bubble water chamber.

4. The shower water supply device according to claim 2, wherein:
during the single shower water discharge cycle, the inlet pipe supplies water to the control pipe for a first time and the valve core is limited at the second control end under water pressure such that water is sprayed from the first outlet of the first outlet pipe and the shower water chamber sprays water;
when the inlet pipe stops supplying water after the first time, the valve core is pulled upward and moved to the first control end by an inertial pulling force of water flow in the first outlet pipe; and
when the inlet pipe starts to supply water to the control pipe for a second time after a preset water supply stopping interval in order to limit the valve core at the second control end by water pressure after the valve core has dropped down to the second control end, the first outlet pipe discharges water to spray water from the shower water chamber.

5. The shower water supply device according to claim 3 or 4, wherein a height of the first outlet is lower than a height of the first control end in order for the valve core to be coupled to and maintained at the first control end under a gravitational force of water flow in the first outlet pipe.

6. The shower water supply device according to claim 1, wherein the first control end is provided with a first step for limiting the valve core, and the second control end is provided with a second step for limiting the valve core.

7. The shower water supply device according to claim 6, wherein there is a clearance between the valve core and the second step.

8. The shower water supply device according to claim 1, wherein a clearance between the valve core and an inner wall of the control pipe is L, wherein 0.1 mm≤L≤2 mm.

9. The shower water supply device according to claim 1, wherein the inlet pipe includes a one-way control member configured to allow one-way water flow from the inlet pipe into the control pipe.

10. The shower water supply device according to claim 9, wherein one end of the inlet pipe comprises a connecting bend, the connecting bend coupled to the side opening, the connecting bend provided either horizontally or downwardly obliquely in a direction towards the side opening, the one-way control member positioned inside the connecting bend.

11. The shower water supply device according to claim 1, wherein:
shower water is a pressurized water; and
the control member comprises a control switch, the control switch positioned on the inlet pipe or on a water supply component for the pressurized water, the control switch configured to control water discharge from the shower water chamber or the bubble water chamber by controlling on-and-off of the control switch.

12. The shower water supply device according to claim 11, wherein the water supply component is a shower column or a shower pipe, the water supply component includes a control base and the control switch is located on the control base.

13. A water discharge method using the shower water supply device according to claim 1 comprising:
using the control member to control on-and-off of the water supply from the inlet pipe to the control member to control the discharge of water from the shower water chamber or the bubble water chamber.

14. The water discharge method of the shower water supply device according to claim 13, further comprising:
disposing the first control end above the second control end;
controlling, by the control member, the inlet pipe in order to supply water to the control pipe for a first time such that at the first time, the valve core is limited at the second control end under water pressure and at this point a shower water passes through the inlet pipe, the control pipe, and the first outlet pipe to make the shower water chamber spray water;
controlling, by the control member, the inlet pipe to stop supplying water after the first time such that after the first time, the valve core is pulled upward and moved to and abuts against the first control end by an inertial pulling force of water flow in the first outlet pipe; and
controlling, by the control member, the inlet pipe to start to supply water to the control pipe for a second time according to a second water supply time before or at a preset water supply stopping interval such that the valve core is limited at the first control end by water pressure before the valve core falls, and the second outlet pipe discharges water to spray bubble water from the bubble water chamber.

15. The water discharge method of the shower water supply device according to claim 13, further comprising:
disposing the first control end above the second control end;
controlling, by the control member, the inlet pipe in order to supply water to the control pipe for a first time such that at the first time, the valve core is limited at the second control end under water pressure and at this point a shower water passes through the inlet pipe, the control pipe, and the first outlet pipe to make the shower water chamber spray water;
controlling, by the control member, the inlet pipe to stop supplying water after the first time such that after the first time, the valve core is pulled upward and moved to and abuts against the first control end by an inertial pulling force of water flow in the first outlet pipe; and
controlling, by the control member, the inlet pipe to start to supply water to the control pipe for a second time after a preset water supply stopping interval, to limit the valve core at the second control end by water pressure after the valve core has dropped down to the second control end, and the first outlet pipe discharges water to spray water from the shower water chamber.
